(19) United States
(12) Patent Application Publication
(10) Pub. No.: US 2006/0100844 A1
(43) Pub. Date: May 11, 2006

(54) Test time forecast system and method thereof

(76) Inventors: Keng-Chia Yang, Chung-Hwa City (TW); Yi-Sheng Huang, Sanchong City (TW); Ben-Hui Yu, Hsinchu City (TW); Chung-Lin Hsieh, Kaohsiung City (TW); Chien-Wei Wang, Hsinchu City (TW); Tsung-Hsin Yang, Shanhua Township (TW); Tzu-Cheng Huang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/983,817

(22) Filed: Nov. 8, 2004

(51) Int. Cl. G06F 13/10

(52) U.S. Cl. 703/21

(57) ABSTRACT

A system and method thereof for test time forecasting. The system comprises a storage device and a first program module. The storage device stores Circuit Probing (CP) test records individually storing information regarding a test time and a yield of a test unit corresponding to a test program. The first program module receives the CP test records and generates a new test time forecast model according to the CP test records. The new test time forecast model determines a dependent variable corresponding to the test time by utilizing an independent variable corresponding to the yield.

### BACKGROUND

The present invention relates to data forecast technology, and more particularly, to a method and system of test time forecasting.

A conventional semiconductor factory typically includes the requisite fabrication tools to process semiconductor wafers for a particular purpose, such as photolithography, chemical-mechanical polishing, or chemical vapor deposition. During manufacturing, the semiconductor wafer passes through a series of process steps, which are performed by various fabrication tools. For example, in the production of an integrated semiconductor product, the semiconductor wafer passes through up to 600 process steps. The costs for such automated production are influenced to a great extent by the question as to how well and efficiently the manufacturing process can be monitored or controlled, so that the ratio of defect-free products to the overall number of products manufactured (i.e., yield ratio) achieves as great a value as possible. The individual process steps, however, are subject to fluctuations and irregularities, which in the worst case may mean, for example, the defect of a number of chips or the entire wafer. Therefore, each individual process step must be carried out as stably as possible in order to ensure an acceptable yield after the completed processing of a wafer.

Circuit probing (CP) testing systems/methods have been used in a variety of semiconductor fabrication processes for yield data acquisition. A test program is provided by a user or an operator to perform CP test for a particular semiconductor product. The test program describes a test flow including multiple test items, and the test items are usually optimally arranged to reduce CP test time. A CP test station then follows the predefined test flow to sequentially probe all dies on a wafer to determine whether a die is good or bad. After completing the entire CP test, yield values for wafers, wafer lots or semiconductor devices are acquired.

Conventionally, CP test time is often associated with test cost, with longer time meaning higher cost, and shorter time meaning less cost. Thus, an important issue in CP data analysis is test time forecasting for determining the probable duration of an upcoming test time for a particular test program based on a large amount of historical data. The forecasted test time is then utilized by sales or marketing clerks to price various test programs for semiconductor devices.

In the past, underestimation of CP test time often results in great extent of profit loss. Therefore, a need exists for a system and method of test time forecast that provides an effective estimation model for various test programs, thereby avoiding profit loss.

### SUMMARY

It is therefore an object of the present invention to provide a system and method of test time forecast that provides an effective estimation model for various test programs, thereby avoiding profit loss.

According to an embodiment of the invention, the system and method thereof comprises a storage device and a first program module, a second program module, a third program module and a fourth program module.

The storage device stores Circuit Probing (CP) test records individually storing information regarding a test time and a yield of a test unit corresponding to a test program. The CP test record comprises a test program identity (ID) corresponding to the test program, the test time and the yield value.

The first program module receives the CP test records and generates a new test time forecast model according to the CP test records. The new test time forecast model determines a dependent variable corresponding to the test time by utilizing an independent variable corresponding to the yield. The new test time forecast model comprises a linear regression model, a multi-regression model, a neural network forecast model or a nonlinear regression model.

The second program module removes the CP test records comprising outlier data of the test time preferably using Tukey method.

The third program module generates a measurement value corresponding to the new test time forecast model and stores the new test time forecast model if the measurement value exceeds a measurement threshold, the measurement value representing interpretation ability of the new test time forecast model. Specifically, the third program module stores the new test time forecast model in the storage device if the measurement value exceeds a first measurement threshold and a previous test forecast model corresponding to the test program is absent, stores the new test time forecast model to the storage device if the measurement value exceeds a second measurement threshold and yield trend corresponding to the test program is improving, and stores the new test time forecast model to the storage device if the measurement value exceeds a third measurement threshold and yield trend corresponding to the test program is steady, the measurement value, preferably r-square measure, representing interpretation ability of the new test time forecast model.

The fourth program module generates a new upper test time forecast model and a new lower test time forecast model through a plurality of re-sampling procedures, and respectively replaces the previous test time forecast model, an previous upper test time forecast model and an previous lower test time forecast model with the new test time forecast model, the new upper test time forecast model and the new test time forecast model if the new test time forecast model is out of an acceptable range between the previous upper test time forecast model and the previous lower test time forecast model.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a diagram of the system architecture of the test time forecast according to the present invention;

FIG. 2 is a diagram of the software architecture of the test time forecast system according to the invention;

FIG. 3 is a diagram of box-and-Whisker graph according to the present invention;

FIG. 4 is a scatter plot diagram showing an exemplary linear regression model according to the present invention;

FIG. 5 is a scatter plot diagram showing another exemplary linear regression model according to the present invention;

FIG. 6 is a flowchart showing a method of test time forecast according to the present invention;

FIG. 7 is a diagram of storage medium for a computer program providing the method of test time forecast according to the invention.

### DESCRIPTION

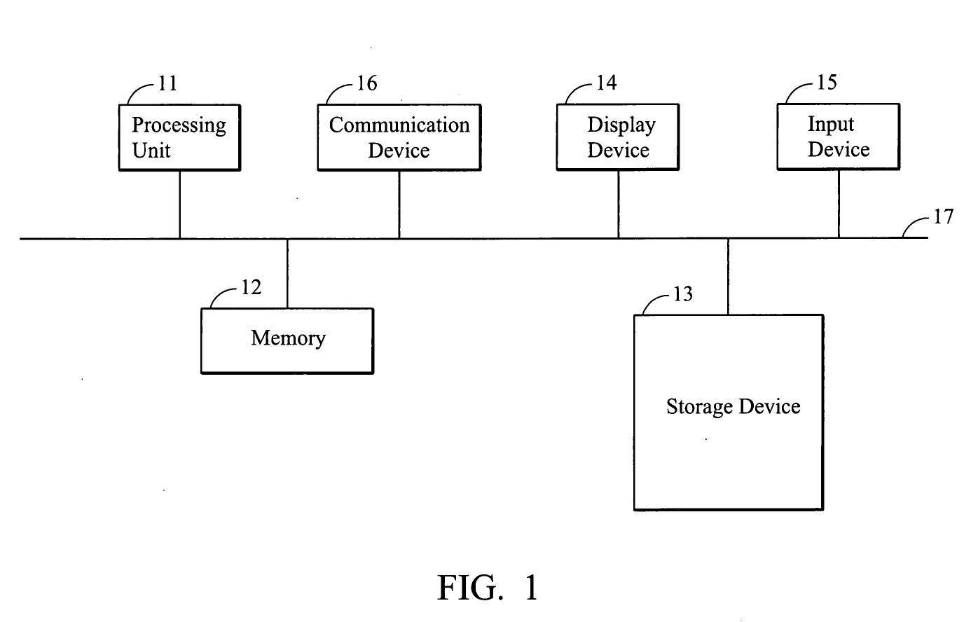

FIG. 1 is a diagram of the system architecture of, the test time forecast according to the present invention. The system 10 includes a processing unit 11, a memory 12, a storage device 13, an input device 14, a display device 15 and a communication device 16. The processing unit 11 is connected by buses 17 to the memory 12, storage device 13, input device 14, display device 15 and communication device 16 based on Von Neumann architecture. The processing unit 11, memory 12, storage device 13, display device 14, input device 15 and communication device 16 may be conventionally comprised in a mainframe computer, a mini-computer, a workstation computer, a host computer, a personal computer, or a mobile computer.

The processing unit 11, controlled by instructions from the memory 12 and an operator through the input device 15, executes test time forecast functions. There may be only one or there may be more than one processing unit 11, such that the processor of computer 10 comprises a single central processing unit (CPU), or multiple processing units, commonly referred to as a parallel processing environment.

The storage device 13 can be implemented as a database system, a file, or the like, to store multiple CP test records. Each CP test record stores information regarding test time and a yield value of a test unit, such as a die, a wafer or others, for a particular test program, preferably comprising a test program identity (ID), a test time and a yield. Those skilled in the art will recognize that the test program ID is associated with a particular semiconductor product. The implementation of the CP test records described above is not limited to a single table/file, but also to multiple related tables/files. Consistent with the scope and spirit of the invention, additional or different fields may be provided. For example, the CP test record may comprise a test program ID, a start time, an end time and a yield.

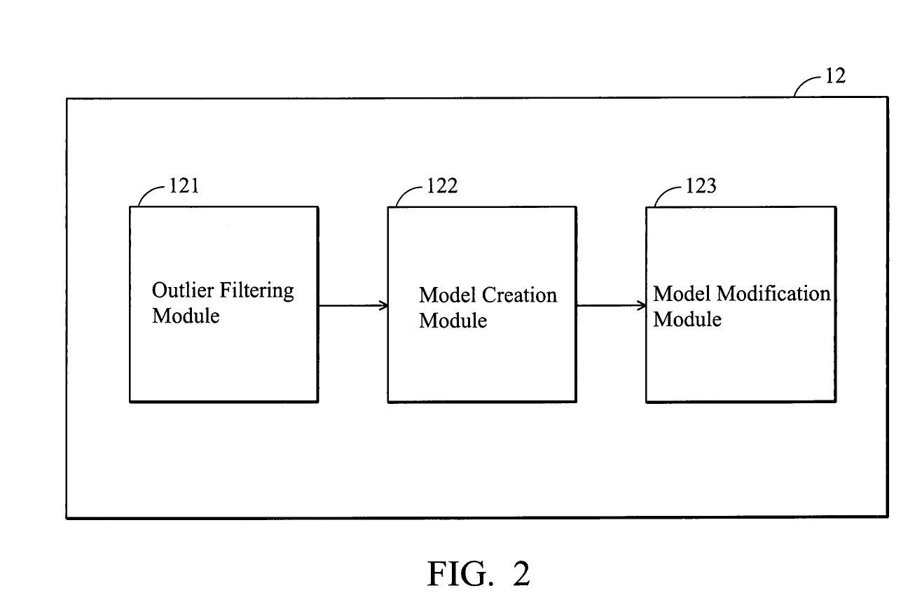

FIG. 2 is a diagram of the software architecture of the test time forecast system according to the invention. The memory 12 is preferably a random access memory (RAM), but may also include read-only memory (ROM) or flash ROM. The memory 12 preferably includes an outlier filtering module 121, a model creation module 122, a model modification module 123 and a test time calculation module (not shown), which include program routines, functions, objects or components to perform test time forecast functions.

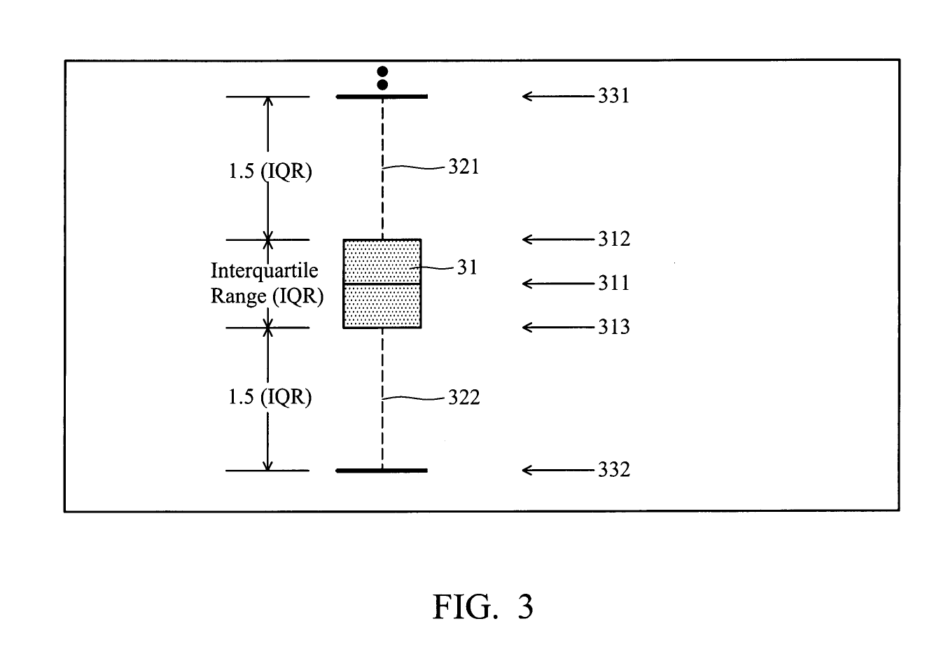

In order to improve the validity and reliability of the forecast model, the outlier filtering module 121 removes outliers of test time from CP test records by various filtering methods or algorithms, such as Tukey method, 3-sigma filtering algorithm, percentile filtering method or others. In this example, the outlier filtering module 121 employs the Tukey method to remove outlier data. FIG. 3 is a diagram of box-and-Whisker graph according to the present invention. The box-and-whisker graph illustrates the statistical distribution (or spread) of a variable (i.e., test time). Referring to the middle of the graph, a box 31 encloses 50 percent of the CP test time (called the interquartile range, IQR). In the box 31, a median line represents the median or mean value of test time, an upper “hinge” 312 of the box 31 represents the 75th percentile value of test time, and a lower “hinge” 313 of the box 31 represents the 25th percentile value of test time. A dotted line 321, the upper whisker (or tail), extends 1.5 times the IQR length from the upper “hinge” 312, and a dotted line 322, the lower whisker (or tail), extends 1.5 times the IQR length from the lower “hinge” 313. An upper fence line 331 represents an upper fence value adding 1.5 times of IQR length to the 75th percentile value, and a lower fence line 332 represents a lower fence value subtracting 1.5 times of IQR length from the 25th percentile value. The Tucky method removes CP test time records wherein the test time exceeds the upper or lower fence value. Those skilled in the art will recognize the outlier filtering module 121 may be omitted to increase performance if the CP test data is perfect for model establishment.

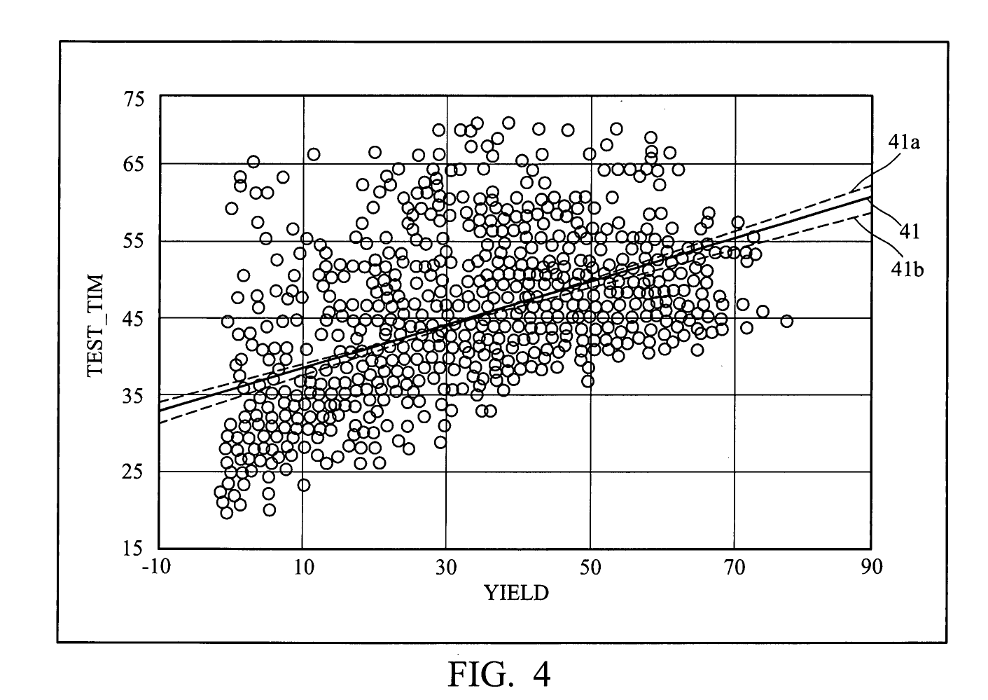

In a CP test, a wafer with a higher yield consumes more test time in probing dices than another wafer with a lower yield. The model creation module 122 establishes a new test time forecast model using various techniques, such as neural network forecast model, linear regression analysis, multiple regression analysis, nonlinear regression analysis, genetic algorithms or others. The new test time forecast model forecasts (e.g. determines) a dependent variable (i.e., test time) according to an independent variable (i.e., yield) based on a large amount of historical data (i.e., CP test records). In this example, the model creation module 122 employs linear regression analysis to establish a new test time forecast model. Equation (1) shows the linear regression model for forecasting the test time.
Y=α+βX, Equation (1):
where Y represents the dependent variable of test time, X represents the independent variable of yield, α represents the intercept (the value of Y when X is zero), and β represents the slope (the change in Y per one unit change in X). Linear regression analysis is employed to generate a best-fit straight line, i.e., calculate α and β in equation (1), among historical data plots. FIG. 4 is a scatter plot diagram showing an exemplary linear regression model according to the present invention. Line 41 represents a best-fit straight line in test time (y axis) versus yield (x axis) among hundreds of historical data. In principle, there are various criteria that might be utilized: minimizing the mean deviation, mean absolute deviation, or median deviation. In this example, due to the technical considerations, the best-fit straight line minimizes the sum of the squared deviation of each point about the line. It is noted that the generation of the linear regression model is well known in the art and as such is only described briefly herein. The model creation module 122 additionally generates a measurement value to quantify the extent to which the straight line fits the data. The measurement value most often used, the r-square measure, has the dual advantages of falling on a standardized scale and having a practical interpretation. The r-square measure (which is the correlation squared, or r², when there is a single predicator variable) is on a scale from 0 (no linear association) to 1 (perfect linear prediction). Also, the r-square value can be interpreted as the portion of variation in test time that can be predicted from yield. For example, an r-square of 0.5 indicates that we can account for 50% of the variation in test time can be accounted for if the yield values are known. The measurement can be seen as the ability to predict test time from yield. It is noted that the generation of r-square value is well known in the art and as such is only described briefly herein.

In order to ensure the effectiveness of test time forecast, the model generation module 122 determines whether the interpretation ability of the new linear regression model is sufficient for a particular test program. Equation (2) shows a formula for assigning a constant to the dependent variable.
Y=t, Equation (2):
where Y represents the dependent variable of test time and c represents the constant indicating an average test time. The average test time for the test program is predefined by an operator. Equation (1) is employed as a new test time forecast model when one of three conditions is satisfied: there is no previous test time forecast model corresponding to the test program and the r-square value of the new test time forecast model exceeds a first measurement threshold (preferably 0.2); the fabrication yield of the semiconductor device corresponding to the test program is improved and the r-square value of the new test time forecast model exceeds a second measurement threshold (preferably 0.15); or the fabrication yield of the semiconductor device corresponding to the test program is steady and the r-square value of the new test time forecast model exceeds a third measure threshold (preferably 0.25). The previous test time forecast model may be detected by extracting version information or an initiation date from the test program or querying a model base storing test time forecast models. The fabrication yield trend of the semiconductor device may be determined by detecting its past CP test records. Preferably, the third measurement threshold is the largest among measurement thresholds and the second is the smallest. Conversely, the equation (2) is employed as the new test time forecast model and stored in the storage device 13, and the entire model creation mechanism ends (i.e., the model modification module 123 is ignored) if all of the above three conditions is dissatisfied.

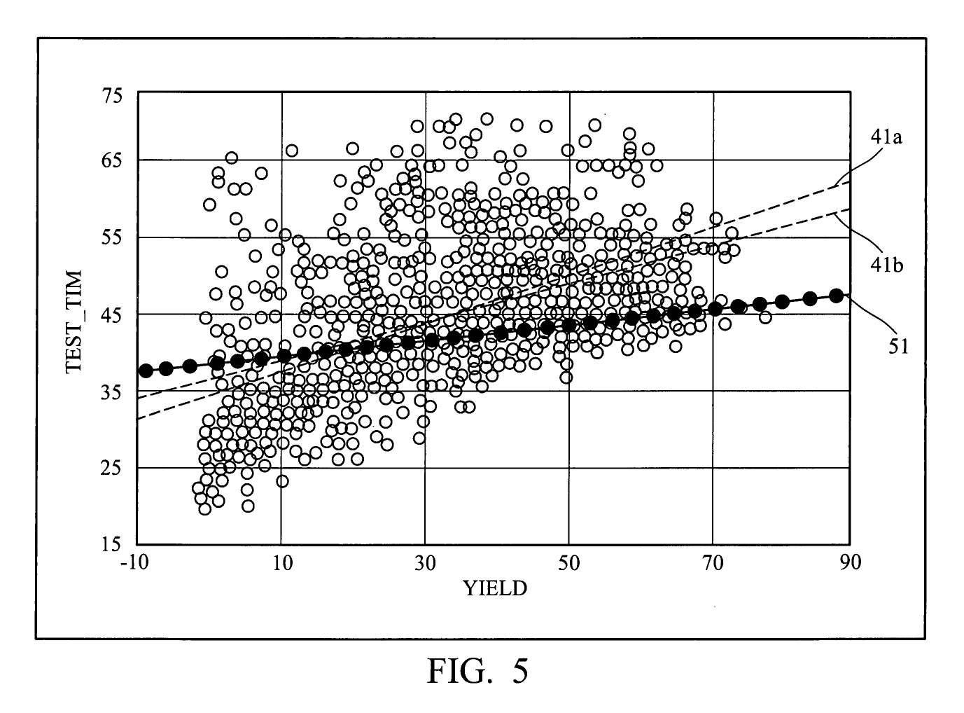

When a new linear regression model is generated, the model modification module 123 performs the remaining functions. The model modification module 123 determines whether a previous test time forecast model corresponding to the same test program is present, if so, a new upper test forecast model and a new lower test forecast model corresponding to the new test forecast model are calculated, and these three models are stored in the storage device 13 for successive test time forecasts. Details of the method for the new upper test forecast model and the new lower test forecast model are further described as follows. Otherwise, the model modification module 123 detects whether the new test forecast model fits into an acceptable range between an upper test forecast model and a lower test forecast model, which correspond to the previous test forecast model, if not, a new upper test forecast model and a new lower test forecast model are generated, and the three new models are stored in the storage device 13 replacing the previous models. Referring again to FIG. 4, straight line 41a illustrates an upper test forecast model and straight line 41b illustrates a lower test forecast model. FIG. 4 illustrates a scenario wherein the new test forecast model falls between an upper test forecast model 41a and a lower test forecast model 41b. FIG. 5 is a scatter plot diagram showing another exemplary linear regression model according to the present invention. FIG. 5 illustrates another scenario wherein the new best-fit straight line 51 does not fall between the upper test forecast model 41a and the lower test forecast model 41b. The new upper forecast model and the new lower forecast model are generated through multiple re-sampling procedures for successive test time forecasts. In re-sampling, all CP test records are divided into several small groups. The model modification module 123 employs equation (1) to acquire multiple linear regression models individually for each small group, acquires the uppermost model as a new upper test forecast model and the lowermost model as a new lower test forecast model. It is noted that the generation of multiple linear regression models is well known in the art and as such is only described briefly herein. The remaining mechanisms for successive test time forecasts may be deduced by analogy. Those skilled in the art will recognize model modification module 123 may be omitted to increase performance when the effect of model modification is irrelevant.

The test time calculation module (not shown) receives a yield value by an operator, the other program module within the same computer, or another remote computer, calculates a forecasted test time employing the test time forecast module from the storage device 13 and outputs it on the display device 14 or other output devices (not shown).

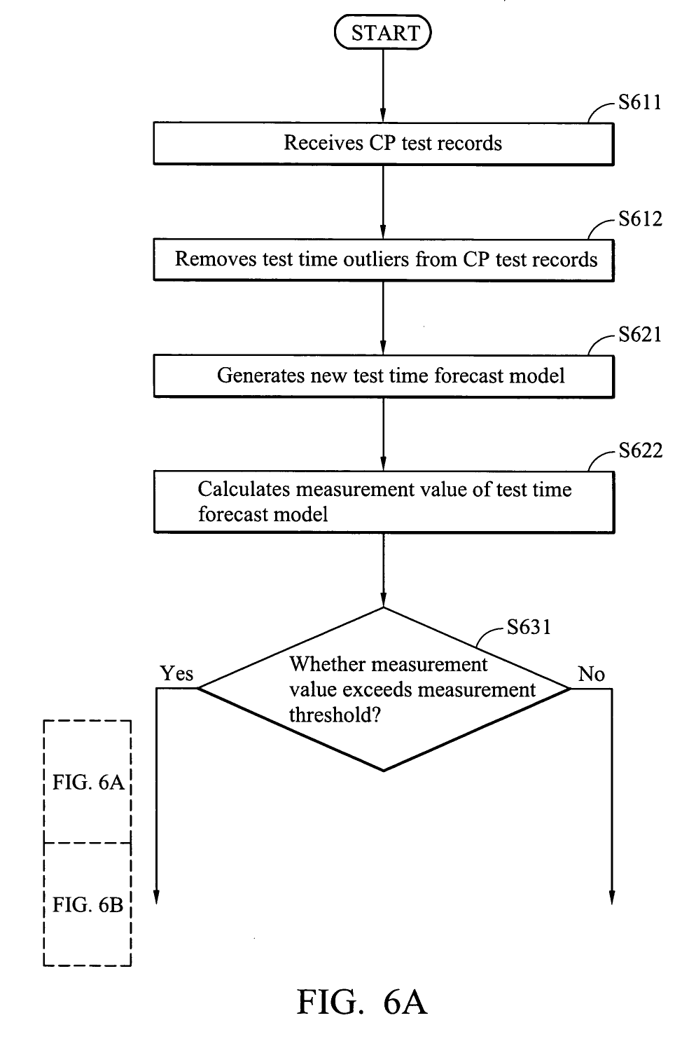

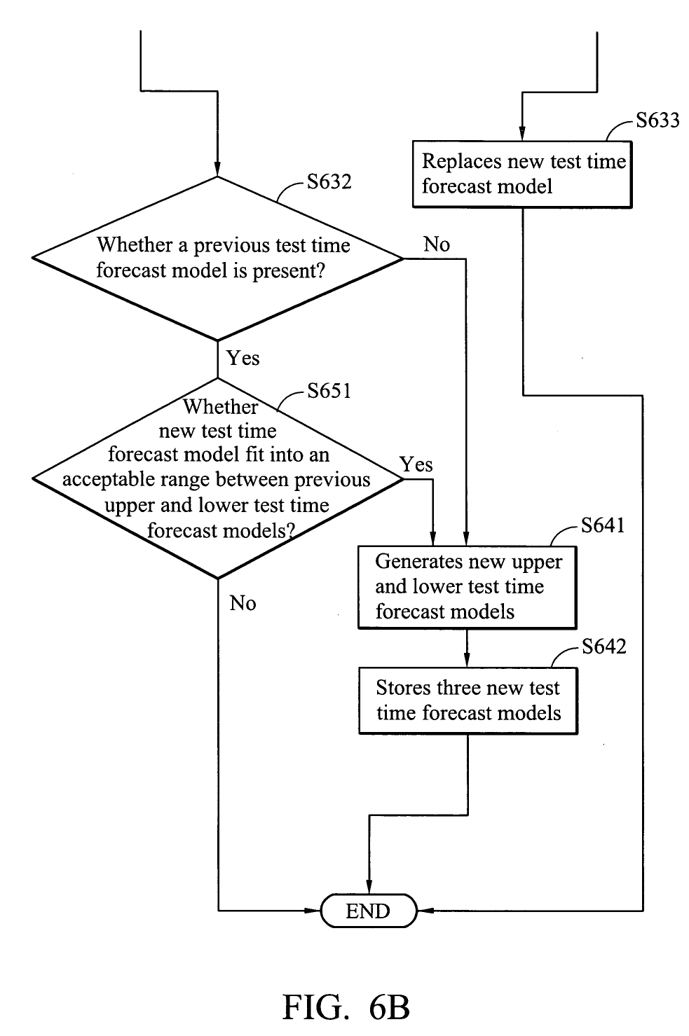

FIG. 6 is a flowchart showing a method of test time forecast according to the present invention. The process begins in step S611 to receive CP test records for a particular test program. In step S612, test time outliers are removed from CP test records by various filtering methods or algorithms, such as the Tukey method, 3-sigma filtering algorithm, percentile filtering method or others. Preferably, step S612 employs the Tuckey method mentioned above to filter test time outliers. Those skilled in the art will recognize step S612 may be omitted to increase performance if the CP test data is perfect for model establishment. In step S621, a new test time forecast model is created using various techniques, such as neural network forecast model, linear regression analysis, multiple regression analysis, nonlinear regression analysis, genetic algorithms or others. The new test time forecast model forecasts a dependent variable of test time according to an independent variable of yield based on the CP test records. Preferably, step S621 employs linear regression analysis mentioned above to create the new test time forecast model. In step 621, a measurement value is calculated to quantify the extent to which the new test time forecast model fits the data from the CP test records (i.e., the interpretation ability of the new test time forecast model). The measurement value preferably is an r-square measure, and the r-square measure (which is the correlation squared, or r², when there is a single predicator variable) is on a scale from 0 (no linear association) to 1 (perfect linear prediction). The step S631 determines whether the measurement value exceeds a measurement threshold, if so, the process proceeds to S632; otherwise, the process proceeds to S633. Step S631 may specifically detect three conditions to determine whether the measurement value exceeds a predefined measurement threshold, wherein, the measurement value exceeds a first measurement threshold when there is no previous test time forecast model corresponding to the test program; the measurement value exceeds a second measurement threshold when the fabrication yield of the semiconductor device corresponding to the test program is improved; or the measurement value exceeds a third measurement threshold when the fabrication yield of the semiconductor device corresponding to the test program is steady. Preferably, the third measurement threshold is the largest among the measurement thresholds and the second threshold is the smallest. In step S633 the new test time forecast model is replaced by equation (2) described above.

Step S632 determines whether a previous test time forecast model is present, if so, the process proceeds to step S651; otherwise, the process proceeds to step S641. In step S641, a new upper forecast model and a new lower forecast model are generated through multiple re-sampling procedures for successive test time forecasts. In re-sampling, all CP test records are divided into several small groups, and multiple test time forecast models are generated individually for each small group. The new upper test forecast model is the uppermost model among the test time forecast models, and the new lower test forecast model is the lowermost model. Preferably, step S641 employs linear regression analysis to generate upper and lower test time forecast models. In step S642, the new test forecast model, and the new upper and lower test forecast models are stored in the storage device 13. Step S651 determines whether the new test time forecast model fits into an acceptable range between a previous upper test time forecast model and a previous lower test time forecast model corresponding to the previous test time forecast model, if so, the process proceeds to step S641; otherwise, the process ends. Those skilled in the art will recognize the steps S632 to S651 may be omitted to improve performance when the effect of model modification is irrelevant.

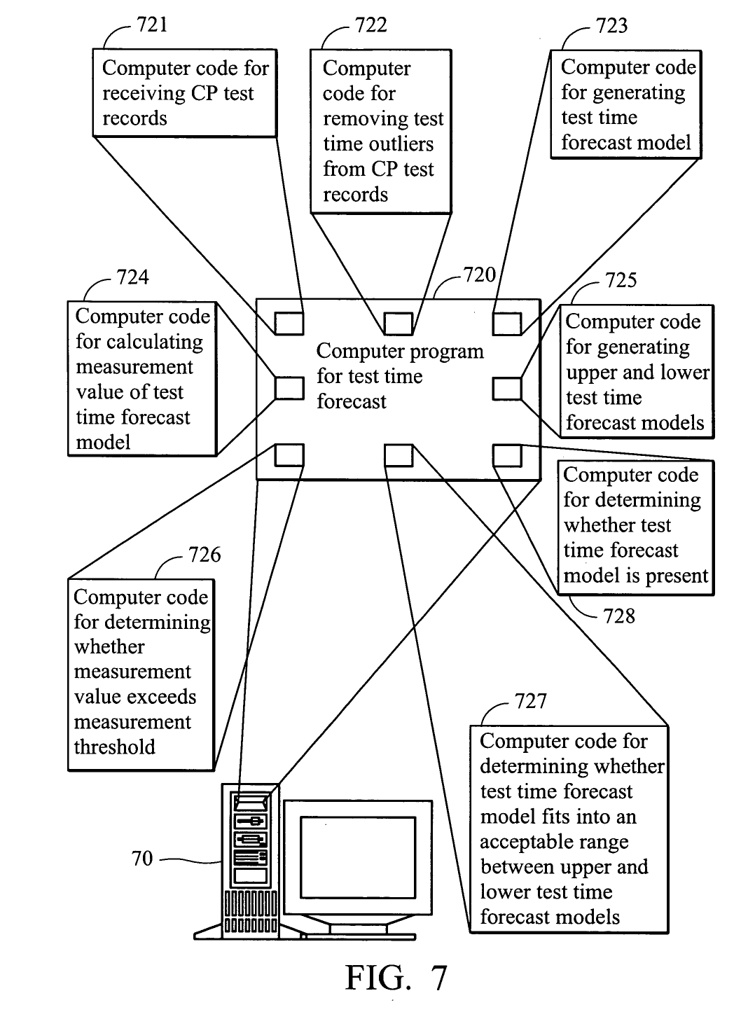

The invention additionally discloses a storage medium as shown in FIG. 7 storing a computer program 720 providing the disclosed method of short passage word calculation. The computer program product includes a storage medium 70 having computer readable program code embodied in the medium for use in a computer system, the computer readable program code comprising at least computer readable program code 721 receiving CP test records, computer readable program code 722 removing outliers from CP test records, computer readable program code 723 generating the test time forecast model, computer readable program code 724 calculating measurement value of the test time forecast model, computer readable program code 725 generating upper and lower test time forecast models, computer readable program code 726 determining whether the measurement value exceeds the measurement threshold, computer readable program code 727 determining whether test time forecast model fits into an acceptable range between upper and lower test time forecast models and computer readable program code 728 determining whether the test time forecast model is present.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of test time forecast, the system comprising:
a storage device, capable of storing a plurality of Circuit Probing (CP) test records, each CP test record storing information regarding a test time and a yield of a test unit corresponding to a test program; and
a first program module, configured to receive the CP test records and generate a new test time forecast model according to the CP test records, the new test time forecast model determining a dependent variable corresponding to the test time by utilizing an independent variable corresponding to the yield.

2. The system of claim 1 wherein the CP test record comprises a test program identity (ID) corresponding to the test program, the test time and the yield value.

3. The system of claim 1 wherein the new test time forecast model comprises a linear regression model, a multi-regression model, a neural network forecast model or a nonlinear regression model.

4. The system of claim 1 further comprising a second program module configured to remove the CP test records comprising outlier data of the test time.

5. The system of claim 4 wherein the CP test records comprising outlier data of the test time are removed by Tukey method.

6. The system of claim 1 further comprising a third program module configured to generate a measurement value corresponding to the new test time forecast model, store the new test time forecast model in the storage device if the measurement value exceeds a first measurement threshold and a previous test forecast model corresponding to the test program is absent, store the new test time forecast model in the storage device if the measurement value exceeds a second measurement threshold and yield trend corresponding to the test program is improving, store the new test time forecast model in the storage device if the measurement value exceeds a third measurement threshold and yield trend corresponding to the test program is steady, the measurement value representing interpretation ability of the new test time forecast model.

7. The system of claim 6 further comprising a fourth program module configured to generate a new upper test time forecast model and a new lower test time forecast model through a plurality of re-sampling procedures if the new test time forecast model does not fall an acceptable range between a previous upper test time forecast model and a previous lower test time forecast model, and respectively replace the previous test time forecast model, the previous upper test time forecast model and the previous lower test time forecast model with the new test time forecast model, the new upper test time forecast model and the new test time forecast model if the new test time forecast model does not fall an acceptable range between the previous upper test time forecast model and the previous lower test time forecast model.

8. The system of claim 1 further comprising a third program module configured to generate a measurement value corresponding to the new test time forecast model and store the new test time forecast model if the measurement value exceeds a measurement threshold, the measurement value representing interpretation ability of the new test time forecast model.

9. The system of claim 8 wherein the new test time forecast model comprises a linear regression model, a multi-regression model or a nonlinear regression model, and the measurement value represents r-square measure.

10. The system of claim 8 further comprising a fourth program module configured to generate a new upper test time forecast model and a new lower test time forecast model through a plurality of re-sampling procedures if the new test time forecast model does not fall an acceptable range between an previous upper test time forecast model and an previous lower test time forecast model, and respectively replace the previous test time forecast model, the previous upper test time forecast model and the previous lower test time forecast model with the new test time forecast model, the new upper test time forecast model and the new test time forecast model if the new test time forecast model does not fall an acceptable range between the previous upper test time forecast model and the previous lower test time forecast model.

11. A method of test time forecast, the method comprising using a computer to perform the steps of:
receiving a plurality of Circuit Probing (CP) test records, each CP test record storing information regarding a test time and a yield of a test unit corresponding to a test program; and
generating a new test time forecast model according to the CP test records, the new test time forecast model determining a dependent variable corresponding to the test time by utilizing an independent variable corresponding to the yield.

12. The method of claim 11 wherein the CP test record comprises a test program identity (ID) corresponding to the test program, the test time and the yield.

13. The method of claim 11 wherein the new test time forecast model comprises a linear regression model, a multi-regression model, a neural network forecast model or a nonlinear regression model.

14. The method of claim 11 further comprising a step of removing the CP test records comprising outlier data of the test time.

15. The method of claim 14 wherein the CP test records comprising outlier data of the test time are removed by Tukey method.

16. The method of claim 11 further comprising the steps of:
generating a measurement value corresponding to the new test time forecast model, the measurement value representing interpretation ability of the new test time forecast model;
storing the new test time forecast model to the storage device if the measurement value exceeds a first measurement threshold and a previous test forecast model corresponding to the test program is absent;
storing the new test time forecast model to the storage device if the measurement value exceeds a second measurement threshold and yield trend corresponding to the test program is improving; and
storing the new test time forecast model to the storage device if the measurement value exceeds a third measurement threshold and yield trend corresponding to the test program is steady.

17. The method of claim 16 further comprising the steps of:
generating a new upper test time forecast model and a new lower test time forecast model through a plurality of re-sampling procedures if the new test time forecast model does not fall an acceptable range between a previous upper test time forecast model and a previous lower test time forecast model; and
replacing the previous test time forecast model, the previous upper test time forecast model and the previous lower test time forecast model with the new test time forecast model, the new upper test time forecast model and the new test time forecast model respectively if the new test time forecast model does not fall an acceptable range between the previous upper test time forecast model and the previous lower test time forecast model.

18. The method of claim 11 further comprising the steps of:
generating a measurement value corresponding to the new test time forecast model, the measurement value representing interpretation ability of the new test time forecast model; and
storing the new test time forecast model if the measurement value exceeds a measurement threshold.

19. The method of claim 18 wherein the new test time forecast model comprises a linear regression model, a multi-regression model or a nonlinear regression model, and the measurement value represents r-square measure.

20. The method of claim 18 further comprising the steps of:
generating a new upper test time forecast model and a new lower test time forecast model through a plurality of re-sampling procedures if the new test time forecast model does not fall an acceptable range between an previous upper test time forecast model and an previous lower test time forecast model; and
replacing the previous test time forecast model, the previous upper test time forecast model and the previous lower test time forecast model with the new test time forecast model, the new upper test time forecast model and the new test time forecast model respectively if the new test time forecast model does not fall an acceptable range between the previous upper test time forecast model and the previous lower test time forecast model.

21. A machine-readable storage medium for storing a computer program which when executed performs a method of test time forecast, the method comprising the steps of:
receiving a plurality of Circuit Probing (CP) test records, each CP test record storing information regarding a test time and a yield of a test unit corresponding to a test program; and
generating a new test time forecast model according to the CP test records, the new test time forecast model determining a dependent variable corresponding to the test time by utilizing an independent variable corresponding to the yield.

22. The machine-readable storage medium of claim 21 wherein the CP test record comprises a test program identity (ID) corresponding to the test program, the test time and the yield value.

23. The machine-readable storage medium of claim 21 wherein the new test time forecast model comprises a linear regression model, a multi-regression model, a neural network forecast model or a nonlinear regression model.

24. The machine-readable storage medium of claim 21, wherein the method further comprises a step of removing the CP test records comprising outlier data of the test time.

25. The machine-readable storage medium of claim 24 wherein the CP test records comprising outlier data of the test time are removed by Tukey method.

26. The machine-readable storage medium of claim 21, wherein the method further comprises the step of:
generating a measurement value corresponding to the new test time forecast model, the measurement value representing interpretation ability of the new test time forecast model;
storing the new test time forecast model to the storage device if the measurement value exceeds a first measurement threshold and a previous test forecast model corresponding to the test program is absent;
storing the new test time forecast model to the storage device if the measurement value exceeds a second measurement threshold and yield trend corresponding to the test program is improving; and
storing the new test time forecast model to the storage device if the measurement value exceeds a third measurement threshold and yield trend corresponding to the test program is steady.

27. The machine-readable storage medium of claim 26, wherein the method further comprises the steps of:
generating a new upper test time forecast model and a new lower test time forecast model through a plurality of re-sampling procedures if the new test time forecast model does not fall an acceptable range between a previous upper test time forecast model and a previous lower test time forecast model; and
replacing the previous test time forecast model, the previous upper test time forecast model and the previous lower test time forecast model with the new test time forecast model, the new upper test time forecast model and the new test time forecast model respectively if the new test time forecast model does not fall an acceptable range between the previous upper test time forecast model and the previous lower test time forecast model.

28. The machine-readable storage medium of claim 21, wherein the method further comprises the steps of:
generating a measurement value corresponding to the new test time forecast model, the measurement value representing interpretation ability of the new test time forecast model; and
storing the new test time forecast model if the measurement value exceeds a measurement threshold.

29. The computer-readable storage medium of claim 28 wherein the new test time forecast model comprises a linear regression model, a multi-regression model or a nonlinear regression model, and the measurement value represents r-square measure.

30. The computer-readable storage medium of claim 28, wherein the method further comprises the steps of:
generating a new upper test time forecast model and a new lower test time forecast model through a plurality of re-sampling procedures if the new test time forecast model does not fall an acceptable range between an previous upper test time forecast model and an previous lower test time forecast model; and
replacing the previous test time forecast model, the previous upper test time forecast model and the previous lower test time forecast model with the new test time forecast model, the new upper test time forecast model and the new test time forecast model respectively if the new test time forecast model does not fall an acceptable range between the previous upper test time forecast model and the previous lower test time forecast model.
